(19) United States
(12) Patent Application Publication
(10) Pub. No.: US 2004/0008968 A1
(43) Pub. Date: Jan. 15, 2004

(54) Photosensitive optical glass

(75) Inventors: Kevin K. Lee, Cambridge, MA (US); Kazumi Wada, Lexington, MA (US); Christian Hoepfner, North Andover, MA (US)

Correspondence Address: HALE AND DORR, LLP, 60 STATE STREET, BOSTON, MA, 02109

(73) Assignee: L3 Optics, Inc., Cambridge, MA (US)

(21) Appl. No.: 10/191,604

(22) Filed: Jul. 9, 2002

(51) Int. Cl. G02B 6/10

(52) U.S. Cl. 385/142; 385/129; 385/132

(57) ABSTRACT

An optical device includes a planar waveguide having a core region at least partially surrounded by a cladding, wherein the waveguide includes of a photosensitive germanium-doped silicon oxynitride (Ge:SiON) or germanium-doped silicon nitride (Ge:SiN). An optical device is formed by providing a photosensitive layer comprised of Ge:SiON or Ge:SiN and selectively irradiating the photosensitive layer at a wavelength of light to which the photosensitive material is sensitive, such that an optical feature having a refractive index different than that of the non-irradiated photosensitive layer is formed. Coupling or decoupling a plurality of optical devices having an optical device layer including two or more optical devices and a photosensitive coupling layer in optical communication with the optical device layer includes selectively irradiating the coupling layer to alter the refractive index in a portion of the layer such that light is directionally coupled or decoupled between the two or more optical devices through the irradiated portion of the coupling layer.

### BACKGROUND OF THE INVENTION

1. Field of the Invention

The invention is in the field of optics and relates to optical materials having increased versatility in varying the refractive index of the material.

2. Description of the Related Art

Germanium-doped SiO₂ (Ge:SiO₂) is a widely used core material for optical fibers and planar waveguides. Germanium (Ge) is doped into silica (SiO₂) to raise the index of the core region relative to the cladding region, which is typically undoped SiO₂. The refractive index difference (Δn) between the Ge-doped SiO₂ core and undoped SiO₂ is quite small. A positive index of about 1% was attained in films containing less than 30 wt % Ge, and a negative index change of about 3% was observed for films containing more than or equal to 30 wt % Ge. See, J. Nishii, Matl. Sci. Engineer. B, B54:1 (1998). Thus it is difficult to use a Ge:SiO₂ core surrounded by SiO₂ cladding for high Δn waveguide.

Ge:SiO₂ shows a significant variation in refractive index with ultraviolet (UV) irradiation. Germanium-doped SiO₂ is sensitive to UV irradiation, and exposure of the material results in a permanent change in the refractive index. Photoirradiation has been used to write periodic index variations into optical materials. The method finds application in making fiber and waveguide gratings.

Silicon oxynitride (SiON) has attracted interest as an optical material in recent years. Depending upon the nitrogen concentration, silicon oxynitride can have a refractive index ranging from that of SiO₂ (1.45-1.50) to that of silicon nitride: SiN (>2.00). In addition, the index of silicon nitride can be extended beyond 2.0 by making it silicon-rich. The index of silicon-rich silicon nitride can go up to ˜3.5. This large flexibility in choosing refractive index adds to the attractiveness of this material for designing integrated optical circuits.

Attempts have been made to identify photosensitive materials that do not contain germanium. For example, UV sensitivity has been observed in hydrogen-rich silicon oxynitride glass; however, the total index change on UV exposure was insignificant (Δn of about 10⁻⁶).

SiON layers have been implanted with Ge⁺ ions and annealed under hydrostatic pressure. Hydrostatic annealing enhances intensity of violet and green photoluminescence in Ge+ ion-implanted SiON.

### SUMMARY OF THE INVENTION

The present invention relates to an optical device, such as an optical fiber or planar device, having a region of germanium-doped silicon oxynitride exhibiting a photorefractive effect. The present invention provides a photosensitive material with a range of refractive indices and the ability to have them further varied by UV irradiation. UV irradiation can be used to write index patterns into the device, to fine-tune the index of the material or to selectively couple or decouple optical devices. In other aspects of the invention, UV irradiation is used to form an optical device on a blank layer or film.

In one aspect of the present invention, an optical device includes a planar waveguide having a core region at least partially surrounded by a cladding, wherein the waveguide is comprised of a photosensitive germanium-doped silicon oxynitride (Ge:SiON) or germanium-doped silicon nitride (Ge:SiN).

In one or more embodiments, the optical device includes a high index difference waveguide containing germanium-doped silicon oxynitride or germanium-doped silicon nitride in the core or in the cladding of the waveguide.

In another aspect of the invention, a method of tuning a waveguide device includes providing a waveguide device comprising a core and a cladding surrounding said core, wherein at least one material of the core and the cladding comprises a photosensitive Ge:SiON or Ge:SiN material; and irradiating the device at a wavelength of light to which the photosensitive material is sensitive, whereby the refractive index of the photosensitive material is altered.

The materials of the present invention exhibit a photorefractive effect, by which it is meant that exposure of the material to light, e.g., UV light, causes a permanent change in the refractive index of the material. The change in refractive index is a function of the radiation dose (time and intensity of exposure) and the dopant level of germanium in the silicon oxynitride.

In another aspect of the invention, a method of forming an optical device is provided. The method includes providing a photosensitive layer comprised of a material selected from the group consisting of Ge:SiO₂, Ge:SiON and Ge:SiN; and selectively irradiating the photosensitive layer at a wavelength of light to which the photosensitive material is sensitive, such that an optical feature having a refractive index different than that of the non-irradiated photosensitive layer is formed.

In another aspect of the invention, a method of coupling or decoupling a plurality of optical elements is provided, which includes providing an optical device layer comprising two or more optical elements; providing a coupling layer in optical communication with the optical device layer, the coupling layer comprising a photosensitive material; and selectively irradiating the coupling layer to alter the refractive index in a portion of the layer such that light is directionally coupled or decoupled between the two or more optical elements through the irradiated portion of the coupling layer.

### BRIEF DESCRIPTION OF THE DRAWING

Various objects, features, and advantages of the present invention can be more fully appreciated with reference to the following detailed description of the invention when considered in connection with the following drawing, in which like reference numerals identify like elements. The following drawings are for the purpose of illustration only and are not intended to be limiting of the invention, the scope of which is set forth in the claims that follow.

FIGS. 1A-1D are cross-sectional illustrations of planar optical devices according to one or more embodiments of the present invention for which a photosensitive Ge-doped SiON or Ge-doped SiN is used as a cladding or core material;

FIG. 2 is a cross-sectional illustration of an optical device according to one or more embodiments of the present invention in which a grating is written into the photosensitive Ge-doped SiON or Ge-doped SiN material;

FIG. 3 is an illustration of a tunable microring resonator according to one or more embodiments of the present invention;

FIG. 4 is an illustration of a method according to one or more embodiments of the present invention used to form an optical device in a film layer; and

FIGS. 5A-5C are cross-sectional illustrations of exemplary photosensitive layers that can provide optical connections among different optical elements on a separate layer according to one aspect of the present invention; and

FIG. 6 is a cross-sectional illustration of a pair of optical devices that are coupled according to one or more embodiments of the present invention.

### DETAILED DESCRIPTION OF THE INVENTION

An optical waveguide including germanium-doped silicon oxynitride (Ge:SiON) or germanium-doped silicon nitride (Ge:SiN) is provided. The relative amounts of oxygen and nitrogen can vary widely, dependent upon the desired refractive index of the material. Thus, the relative atomic proportions of oxygen and nitrogen (O:N) of the SiON host can range from 99.9:0.1 O:N to 0.1:99.1 O:N. This represents a composition control of 0.1%, which is attainable using standard techniques. As the oxygen level approaches that found in silicon dioxide, the index falls and approaches the index for silica (1.45-1.5). Similarly, as the nitrogen level approaches that found in silicon nitride, the index rises and approaches that of silicon nitride (≧2.0). The index of silicon nitride can vary from 2.0 to ˜3.5 by making the silicon nitride material silicon-rich. There is a continuous index range from that of SiN to amorphous silicon that can be used in one or more embodiments of the invention. Therefore, between silicon oxynitride and silicon nitride, an index range of 1.45 to 3.5 is made possible. The silicon oxynitride or silicon nitride host itself can be a doped host. For example, the host can include boron and/or phosphorus.

Germanium doping changes the index of the SiON or SiN host. Although the index change due to germanium doping is relatively small compared to the large index range of SiON, this additional level of index control is another tool that can be used to achieve the desired refractive index. In one or more embodiments, the levels of O, N and Ge are selected to provide a material having a refractive index that closely approximates the desired index.

Further modification or tuning of the index is accomplished by taking advantage of the photosensitivity of the Ge-doped SiON material. Ge:SiON and Ge:SiN are expected to exhibit excellent photosensitivity, thereby providing yet another level of index control. UV irradiation at the absorption of a Ge-related defect increases the refractive index of the sample at longer wavelengths. While the change in the index is a function of the time and intensity of UV radiation exposure, the index change is expected to range from 10⁻³ to a few percent.

In at least some embodiments, the optical device is a high index difference waveguide. High index difference waveguides typically have an index difference between the core and the cladding equal to or greater than 0.3 (i.e., ˜9-20% higher core index than the cladding index) and can be made in a variety of geometries, such as channel and rib waveguides. At least a portion of the cladding can be air. A channel waveguide is a dielectric waveguide whose core is surrounded by a cladding that is composed of a material or materials having a refractive index lower than that of the core. A rib waveguide is a dielectric waveguide whose core is surrounded by a cladding that is composed of two or more materials, of which at least one has the same refractive index as the core. For rib waveguides, the cladding is defined as a region where the evanescent field of the mode exists. In both instances, the peak optical intensity resides in the core. In a rib waveguide, a high index difference waveguide is defined as a waveguide whose modal area is similar to a high index difference channel waveguide.

The optical device can be a patterned device. By “patterned,” as that term is used herein, it is meant that the material or the material index is arranged and/or provided in a predetermined configuration. Most often, the pattern is made using semiconductor fabrication methods, such as lithography. The ability to use patterned elements in the preparation of waveguides and other optical elements and the ability to use conventional semiconductor fabrication techniques permits incorporation of the waveguides and other optical elements of the invention into optical devices or optical chips.

According to one or more embodiments of the invention, an optical device incorporates a photosensitive Ge-doped silicon oxynitride or silicon nitride into either the cladding or the core material.

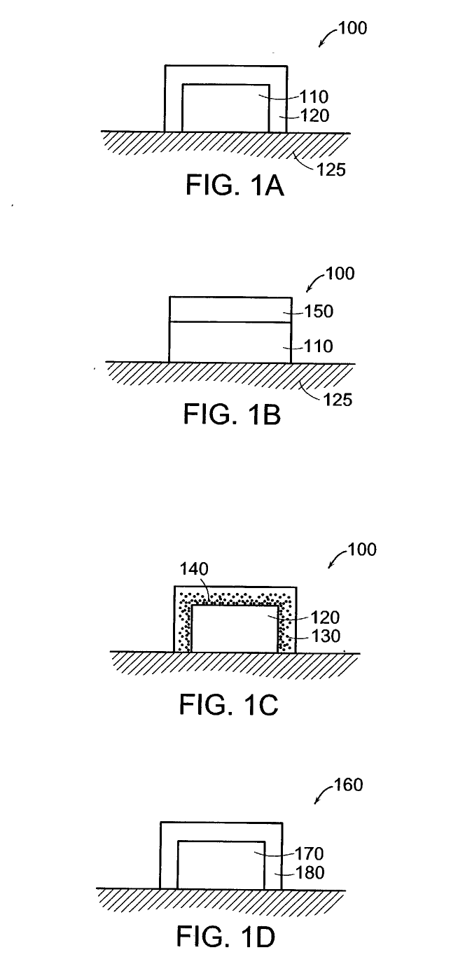

The device can include a high index core and a low index cladding material, in which at least a portion of the cladding material is a low index Ge-doped material, e.g., Ge-doped SiON. As is shown in cross-section in FIG. 1A, the waveguide 100 can include high index core 110, e.g., silicon nitride (n=2.00-2.05, or even ˜3.5) and a low index cladding 120, e.g., Ge-doped SiON, where the relative levels of Ge, O and N are selected so that the refractive index is significantly less than that of silicon nitride. The undercladding 125 is a low index material, such as SiO₂.

In one or more embodiments of the invention, waveguide 160 incorporates Ge-doped SiON or Ge-doped SiN into the waveguide as the high index core 170. Undoped silica (n=1.50), or air (n=1.0), or SiON of lower index can serve as the low index cladding 180, as shown in FIG. 1D. Other conventional cladding materials are contemplated for use in the optical devices of the present invention.

In one or more embodiments of the invention, more than one type of cladding material covers the sides of the core. For example, the cladding can include a top layer 150 of photosensitive material, while the sides use air as the low index cladding, as shown in FIG. 1B. The cladding and/or the core can include a Ge-doped SiON or Ge-doped SiN material.

Alternatively, as is shown in FIG. 1C, the cladding can be a graded cladding 130 with a higher index region 140 located closest to the high index core. The outermost portion of the cladding can have an index close to or equal to that of undoped silica. By way of example only, the low index cladding can be SiON with an increasing index as it approaches the core. Graded coatings can be prepared using conventional techniques, and are helpful in improving optical losses. See, WO 02/04999, hereby incorporated by reference, for further details. The cladding and/or the core can include a Ge-doped SiON or Ge-doped SiN material.

In at least some embodiments, the waveguide includes a grating, e.g., a reflective or transmissive grating, in the high index core. A grating takes the form of periodic variations of higher and lower refractive indices along the longitudinal direction of the device, which act for example as a Bragg grating. The grating selectively reflects (or transmits) light of a specified wavelength. Such gratings can be used to filter, to define laser cavities and as components in multiplexers and demultiplexers.

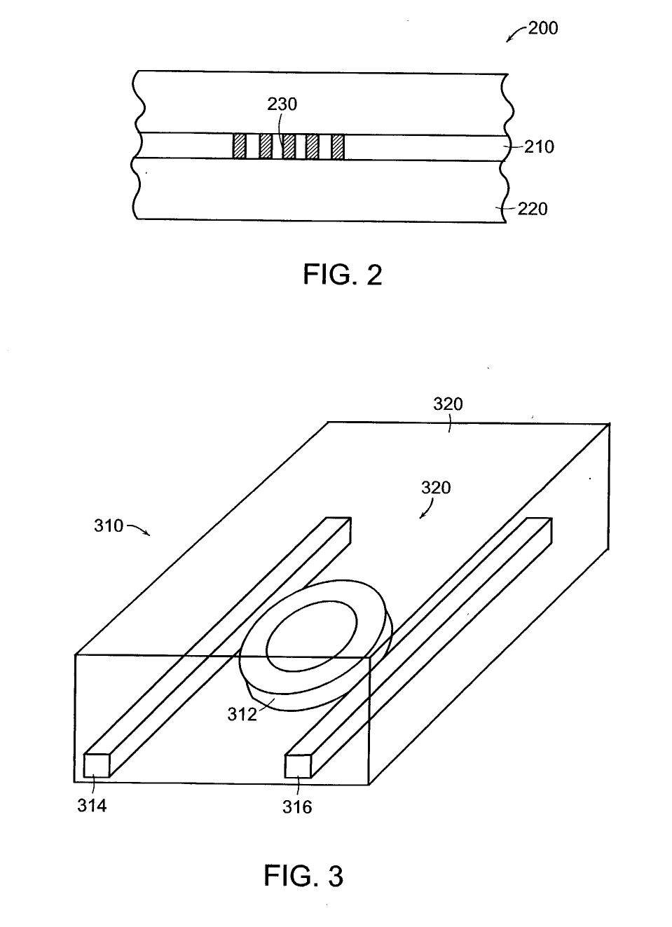

FIG. 2 shows an exemplary waveguide 200 including a grating 230 according to one or more embodiments of the present invention. The waveguide 200 has a photosensitive Ge-doped SiON or Ge-doped SiN core 210 and a low index cladding 220. The core 210 contains a grating 230 therein, which is written into the material by exposure to patterned light, e.g., a linear sequence of intensity peaks. To make such a reflection grating, the region is exposed to a modulated intensity of UV radiation. One approach to generating the UV irradiation of varying intensity is to direct two interfering beams of UV radiation through the device to form an interference pattern within the germanium-doped core (or cladding). Other methods will be readily apparent to practitioners of the art.

According to another aspect of the invention, the index of the waveguide is changed or “tuned” by use of a photosensitive material in the waveguide. Since the waveguide properties are very sensitive to the physical dimensions and material properties in the core and cladding, the actual device characteristics are often different from the calculated or target specifications. It is desired to have an ability to modify (or, in other words, to tune) the device characteristics after the fabrication process to match the specifications of the design.

In at least some embodiments, the tunable waveguide is a microresonator. FIG. 3 is a schematic illustration of an exemplary waveguide microring resonator cavity 310. The microring resonator has a waveguide ring 312 coupled to two bus waveguides 314, 316. Bus waveguides 314, 316 are placed in close proximity (e.g., within the evanescent field) to the microring in order to interact with the resonator mode. The microring resonator is a waveguide of higher index material, e.g., Ge-doped SiON or Ge-doped SiN, in the core surrounded by a lower index cladding material 320, which forms a high confinement (high index difference) waveguide. Light enters the microring 312 from the first bus waveguide 314 and a small fraction of the light energy is then coupled into the ring. After a trip around the ring, light that is resonant in the ring adds in phase with light already resident in the ring. Power then builds up and reaches a steady state. Resonant light is then coupled into the second bus waveguide 316 and exits the microresonator. Wavelengths of light that are off-resonance with the microring never build up power and the energy in the input waveguide travels past the ring without effect. Adjustments of the index in the ring resonator waveguide alter the characteristics of the coupled light energy.

In one or more embodiments, the index of the Ge-doped SiON or Ge-doped SiN is adjusted upwards or downwards by exposure of the device to light 330 of the appropriate wavelength, thereby altering the index difference of the device. Because the light exposure can be in the form of a narrow beam or the light can be focused, it is possible to locally alter the index and, hence, locally tune the optical device. It is appreciated that the device is tunable when the photosensitive Ge-doped SiON is used either as a cladding or as a core.

Tuning is accomplished by exposing the device to UV irradiation at a wavelength to which the device is sensitive. Because the magnitude of the index change is a function of time and intensity of UV exposure, it is possible to incrementally irradiate the device until the desired index shift is accomplished.

The UV irradiation preferentially affects only the UV sensitive layer and leaves the properties of the other layers unchanged. Ge-doped SiON and Ge-doped SiN can be used for either the core or cladding. In those instances where the Ge-doped SiON is used as a core, silica can be used as the cladding, which is transparent to the UV radiation and allows the activating light to penetrate to the core of the waveguide unattenuated. In this sense, it is an optimal tuning process because the other layers are transparent to UV and are not affected, while the tuning energy is directed to the material that can change the refractive index.

In at least some embodiments, the use of UV irradiation permits local tuning of the optical device. By “local” tuning, it is meant that the tuning process is able to isolate and selectively modify an individual optical element, even those elements that are very small, e.g., on the order of microns. In operation, is it contemplate that the optical element such as a waveguide is incorporated into an optical chip, where other optical and/or electrical functions also reside in close proximity. Local tuning permits the selective tuning of the selected element without effecting adjacent elements on the chip.

In another aspect of the present invention, UV irradiation can be used to “write” an optical device in a blank layer. “Blank” layer refers to a layer or region of a layer having no optical device or portion of an optical device therein. The blank layer is a Ge-doped photosensitive layer, whose index is changed locally by local UV irradiation. The optical device is patterned by selectively irradiating the area where the index change in the blank layer is desired. The selective irradiation of UV light can be achieved by conventional methods. Exemplary methods include but are not limited to (1) irradiating UV light through a mask that contains areas which are transparent and opaque to UV light (2) steering (moving) a focused UV beam across the layer surface in the desired pattern (3) use of interference of multiple light beams to write a grating into the layer, and (4) diffraction. The Ge-doped photosensitive material can be one or more of SiO₂, SiON or SiN.

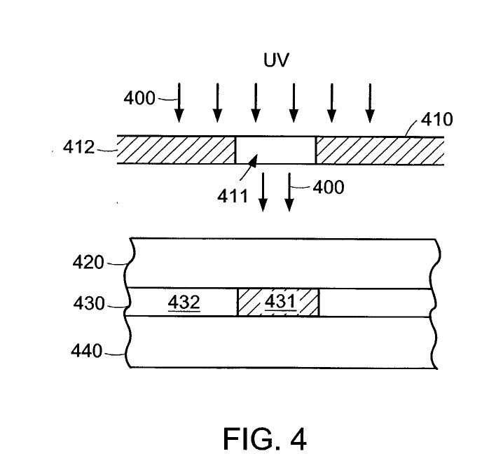

Waveguide core patterning according to one or more embodiments of the present invention using a masking technique is shown in FIG. 4. UV light 400 is irradiated through a mask 410 that contains a UV transparent area 411 and UV opaque area 412. UV light 400 travels through the transparent region 411 and selectively irradiates a portion 431 of the blank Ge:SiON layer 430. The index of only the irradiated area 431 is altered to become a waveguide core whereas the non-irradiated region 432 remains as cladding. In one or more embodiments, cladding layer 420 (and optionally layer 440) is transparent to UV energy, and is not UV-sensitive.

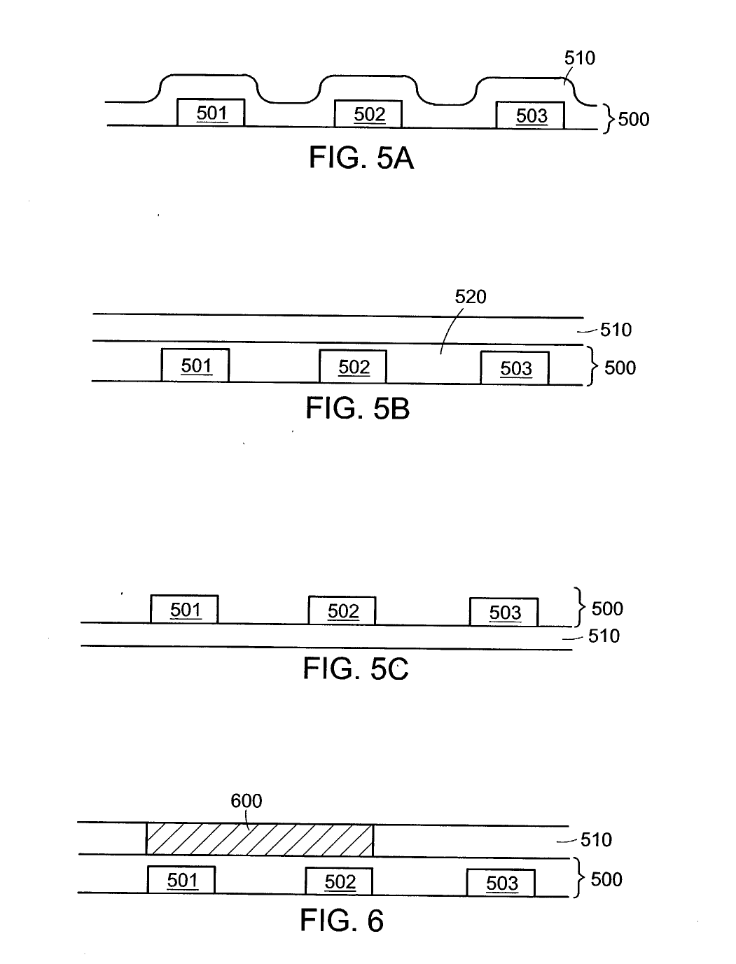

In another aspect of the present invention, a method is provided to selectively activate or deactivate optical connections in an optical device. With reference to FIG. 5, a coupling layer 510 of a photosensitive material such as a Ge:SiON or Ge:SiN is disposed over or under the optical device level 500. The “optical device level” is a layer in the device in which optical elements 501, 502, 503, etc. are located. Exemplary arrangements of the photosensitive coupling layer 510 with respect to the optical device layer 500 are shown in FIGS. 5A through 5C.

FIG. 5A shows coupling layer 510 as a coating deposited directly on and around the optical elements 501, 502, 503. Thus the optical level 500 includes a portion of the blank layer 510, or is integral with the coupling layer 510, which acts as a cladding for the optical elements 501, 502, 503. FIG. 5B illustrates an embodiment of the present invention in which the optical elements 501, 502, 503 are embedded in a cladding 520. The coupling layer 510 is disposed on the cladding layer 520. FIG. 5C illustrates yet another embodiment of the invention, in which the coupling layer 510 is disposed below the optical elements, i.e., as an undercladding. Any suitable cladding material is used; shown here in FIG. 5C, air is used as the cladding material.

The coupling layer 510 is selectively patterned using UV irradiation methods as described above to create regions within the coupling layer having a different refractive index. By selectively irradiating the photosensitive layer, i.e., coupling, one can activate (or deactivate) optical connections among various optical devices in the optical device layer 500. For example, FIG. 6 shows directional coupling between optical element 501 and optical elements 502 by creating an optical waveguide 600 using the selective UV irradiation method of the invention. Light is directionally coupled from optical elements 501 to the waveguide 600, for example, in the manner similar to that described above for a microring resonator, and is guided in the present waveguide 600 until it is directionally coupled into optical element 502. Therefore, an optical “connection” is activated between two optical elements 501 and 502. In a similar manner, optical devices can be decoupled by using UV irradiation by altering the index so that an optical connection no longer exists between two optical elements 501 and 502.

This method of the invention finds application in the fabrication of integrated optical elements on an optical chip. In one or more embodiments of the invention, a plurality of optical elements can be fabricated on an optical chip using conventional semiconductor fabrication methods. A coupling layer of Ge-doped photosensitive material can be deposited above, below or around the optical devices. In one or more embodiments, the regions surrounding the waveguide 600 can be exposed to light so that its index is modified in a manner that creates the waveguide 600. In one or more steps, the photosensitive coupling layer is irradiated, thereby creating one or more optical connections among the chip optical devices. The method provides an accurate and efficient way of creating multiple connections among integrated optical devices on a chip.

In one or more embodiments of the present invention, decoupling and coupling of optical devices can be accomplished using any photosensitive material, for example, Ge-doped SiO₂, Ge-doped SiON and/or Ge-doped SiN, as well as photosensitive optical polymers.

The UV irradiation can be provided by a UV laser or a UV lamp. The UV radiation is typically in the range of 220-390 nm, although other wavelengths of radiation can be used. The localization of the UV irradiation may be accomplished by focusing the light using some optical elements such as lens. However focusing is not required if the beam size is small enough for localized irradiation depending on specific applications.

Ge doping in SiON can be achieved through conventional methods. One method is to mix a Ge-containing precursor with other precursors used to create SiON in a chemical vapor deposition (CVD) process, in particular plasma-enhanced CVD and low-pressure CVD. For example, Ge-doped SiON films are deposited from a mixture of silane (SiH₄), germane (GeH₄), N₂O, and NH₃. Another method is to incorporate Ge in a sputtering process by using a Ge target as well as other targets used to deposit SiON. For example, targets containing varying amounts of Ge, Si, O and N can be used. Sputtering deposition is carried out under an oxidizing atmosphere using a sputtering gas.

Although various embodiments that incorporate the teachings of the present invention have been shown and described in detail herein, those skilled in the art can readily devise many other varied embodiments that incorporate these teachings. All references mentioned herein are incorporated by reference.

What is claimed is:

1. An optical device comprising a planar waveguide having a core region at least partially surrounded by a cladding, wherein the waveguide is comprised of a photosensitive germanium-doped silicon oxynitride (Ge:SiON) or germanium-doped silicon nitride (Ge:SiN).

2. The device of claim 1, wherein the cladding is comprised of Ge:SiON.

3. The device of claim 1 or 2, wherein the core is comprised of Ge:SiON or Ge:SiN.

4. The device of claim 1, wherein the ratio of O to N in Ge:SiON ranges from about 0.1:99.1 to about 99.1:0.1.

5. The device of claim 1, wherein the waveguide is a high index difference waveguide.

6. The device of claim 1, wherein the index of refraction of the core is adjustable in the range of about 2.0 to about 3.5.

7. The device of claim 1, wherein the index of refraction of SiN is variable beyond 2.0 by making is silicon rich.

8. The device of claim 1, wherein the device is a channel waveguide.

9. The device of claim 1, wherein the device is a rib waveguide.

10. The device of claim 5, wherein the difference in index of refraction between the core and the cladding (Δn) is greater than or equal to 0.3.

11. The device of claim 10, wherein the modal area is similar to that of a channel waveguide whose index difference between core and cladding is greater than or equal to 0.3.

12. The device of claim 1, wherein a region of the Ge:SiON material exhibits a pattern of varying refractive indices.

13. The device of claim 12, wherein the index varies such that the waveguide reflects or transmits light of a predetermined wavelength propagating longitudinally in the waveguide.

14. The device of claim 1, wherein a region of the Ge:SiON material has a pattern of refractive index variations that forms a reflection or transmission grating.

15. The device of claim 1, wherein the refractive index of at least a portion of the Ge:SiON material has been altered by exposure to UV radiation.

16. The device of claim 1, wherein the device is selected from the group consisting of optical filters, optical switches, optical resonators, interferometers, and wavelength multiplexers and demultiplexers.

17. A method of tuning a waveguide device comprising:
providing a waveguide device comprising a core and a cladding surrounding said core, wherein at least one material of the core and the cladding comprises a photosensitive Ge:SiON or Ge:SiN material; and
irradiating the device at a wavelength of light to which the photosensitive material is sensitive, whereby the refractive index of the photosensitive material is altered.

18. The method of claim 17, wherein the altering of the refractive index comprises altering the index to match a target specification.

19. The method of claim 17, wherein the irradiating step comprises incrementally exposing the device to UV and determining the change in refractive index between UV exposures.

20. The method of claim 17, wherein the cladding is comprised of Ge:SiON.

21. The method of claim 17, wherein the core is comprised of Ge:SiON or Ge:SiN.

22. The method of claim 17, wherein the ratio of O to N in SiON ranges from about 0.1:99.1 to about 99.1:0.1

23. The method of claim 17, wherein the device is a channel waveguide.

24. The method of claim 17, wherein the device is a rib waveguide.

25. The method of claim 17, wherein the device is a microring resonator.

26. The method of claim 17, wherein the index of refraction of the core is adjustable in the range of about 2.0 to about 3.5.

27. A method of forming an optical device, comprising:
providing a photosensitive layer comprised of a material selected from the group consisting of Ge:SiO₂, Ge:SiON and Ge:SiN; and
selectively irradiating the photosensitive layer at a wavelength of light to which the photosensitive material is sensitive, such that an optical feature having a refractive index different than that of the non-irradiated photosensitive layer is formed.

28. The method of claim 27, wherein the light is UV light.

29. The method of claim 27, wherein the optical device further comprises a cladding layer positioned on the photosensitive layer.

30. The method of claim 29, wherein the cladding layer is positioned on the photosensitive layer prior to irradiation, and the cladding layer is translucent to UV irradiation.

31. The method of claim 27, wherein the step of selectively irradiating the photosensitive layer comprises masking the photosensitive layer with a mask having UV transparent and UV opaque regions.

32. The method of claim 27, wherein the step of selectively irradiating the photosensitive layer comprises exposing a portion of the photosensitive layer to a focused light source and moving the light source across the photosensitive layer in a predetermined pattern.

33. The method of claim 27, wherein the index of refraction of the core is adjustable in the range of about 2.0 to about 3.5.

34. A method of coupling or decoupling a plurality of optical elements, comprising:
providing an optical device layer comprising two or more optical elements;
providing a coupling layer in optical communication with the optical device layer, the coupling layer comprising a photosensitive material; and
selectively irradiating the coupling layer to alter the refractive index in a portion of the layer such that light is directionally coupled or decoupled between the two or more optical elements through the irradiated portion of the coupling layer.

35. The method of claim 34, wherein the optical element includes a waveguide.

36. The method of claim 34, wherein the coupling layer comprises a cladding layer in direct contact with the two or more optical elements.

37. The method of claim 34, wherein the optical device layer comprises a waveguide.

38. The method of claim 34, wherein the optical device layer comprises two or more high index cores and a cladding layer.

39. The method of claim 34, wherein the coupling layer is in physical contact with the cladding.

40. The method of claim 34, wherein the coupling layer is positioned below the optical device layer.

41. The method of claim 40, wherein the cladding is air.

42. The method of claim 34, wherein the step of selectively irradiating comprises masking the coupling layer with a mask having UV translucent and UV opaque regions.

43. The method of claim 34, wherein the step of selectively irradiating comprises exposing a portion of the coupling layer to a focused light source and moving the light source across the coupling layer in a predetermined pattern.
